(19) United States
(12) Patent Application Publication
(10) Pub. No.: US 2007/0122260 A1
(43) Pub. Date: May 31, 2007

(54) Vehicle lift

(76) Inventors: Michael Zablocky, Wyoming, PA (US); John C. Cherko, Conyngham, PA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/606,552

(22) Filed: Nov. 30, 2006

Related U.S. Application Data
(60) Provisional application No. 60/740,726, filed on Nov. 30, 2005.

(51) Int. Cl. B60P 1/00

(52) U.S. Cl. 414/543

(57) ABSTRACT

A lifting device for lifting a smaller vehicle into a transporting vehicle includes attachment structures that are dimensioned and configured to secure the lifting device to attachment points provided on the transporting vehicle without modification of the vehicle. Some examples of the lifting structure include a support arm having a hook that is structured to engage a tailgate-securing bracket. Anther example includes a base having projections depending downward therefrom, or a tailgate-securing bracket, with the projections or bracket being inserted into the tailgate latch to secure the lift to the vehicle.

### CROSS-REFERENCE TO RELATED APPLICATION

This application claims the benefit of U.S. Provisional Application No. 60/740,726 filed on Nov. 30, 2005.

### FIELD OF THE INVENTION

The present invention relates generally to a lift for an object, such as a relatively smaller vehicle, for storing it within a transporting vehicle such as an automobile. In particular, the present invention relates to a system of attaching a lift to an automobile structure.

### BACKGROUND OF THE INVENTION

Many disabled individuals rely on small power driven vehicles for mobility. There are a number of such mobility devices sold under many brand names. Such vehicles include personal mobility vehicles, scooters and powered wheelchairs. Generally, these small vehicles are transported in a larger automobile or other transporting vehicle, such as a van, car or truck, and are unloaded when they are to be used. The mobility vehicles typically weigh in excess of 150 pounds and therefore it may be necessary to use some type of lifting device or ramp for loading and unloading the vehicle to and from the automobile.

One form of lifting device comprises a boom structure that is typically mounted in a vehicle trunk or adjacent the rear or side door opening. Such lifting device typically includes a support base and a boom arm. One example of such a lifting device is shown in U.S. Pat. No. 5,431,526. The lifting device in the '526 patent includes a stand portion which is bolted to the floor or floor boards of the automobile. An upstanding shaft supports a boom arm at the upper end thereof. A reversible motor drive is provided on the boom arm. The motor selectively rotates a drum on which is wound a lifting cable or strap. The strap extends along the boom arm and projects from the distal end. The strap terminates in a hook or claw, which is securable to the vehicle. The boom assembly is axially adjustable and the angular relationship of the boom to the vertical shaft is adjustable.

A lifting assembly for carrying small recreational vehicles and storing them in the back of a pickup truck is shown in U.S. Pat. No. 5,752,799. The lifting structure may be attached to a trailer hitch secured to the truck. In U.S. Pat. No. 6,007,289, the lifting assembly is attached to the rear bumper of an automobile or may be attached to a trailer hitch-type structure.

In FIGS. 1 and 2 of the present application, there is shown a base portion for a lifting structure of the type that is known in the prior art. The base 2 includes a central support plate 4 attached to extendable support arms 6. Each support arm telescopes to expand the platform area of the base. At the end of each support arm 6 is provided a mounting plate 8 having a opening therein for receipt of a bolt or the like, which may be inserted into the floor or frame structure of an automobile for fixing the base 2 in a stationary position. FIG. 1 shows an upstanding post 10 extending out of the mounting plate 4, which supports a vertical shaft (not shown) of the lifting device. In FIG. 2, the bottom surface of the support plate 4 is illustrated.

It is the object of the present invention to provide a lifting device having an attachment structure which releasably secures the lifting device to the existing vehicle structures.

### SUMMARY OF INVENTION

A lifting device is provided for lifting objects into and out of a transporting vehicle, such as an automobile. The lifting device includes a base, which is securable to the automobile, a vertical support shaft projecting upwardly from the base, and a boom arm upwardly angled from the support shaft. A motor drive is secured at the top of the boom arm. The motor reversibly moves a cable structure which extends from the projected end of the boom arm. The cable includes a hook at one end, which is securable to a mobility vehicle or other object that is desired to be lifted into the automobile. The lift is secured to the transporting vehicle by attachment to at least one existing structure on the vehicle, and preferably multiple structures. The attachment permits the releasable securing of the lift to the vehicle without modification to the transporting vehicle, permitting the lift to be broken down and stored in between lifting operations.

### BRIEF DESCRIPTION OF THE DRAWINGS

For the purpose of illustrating the invention, the drawings show one or more forms in which the invention can be embodied. The invention is not, however, limited to the precise form shown unless such limitation is expressly made in a claim.

FIG. 1 is an isometric top view of a base structure for a lifting device for a mobility vehicle or the like of the type which is found in the prior art.

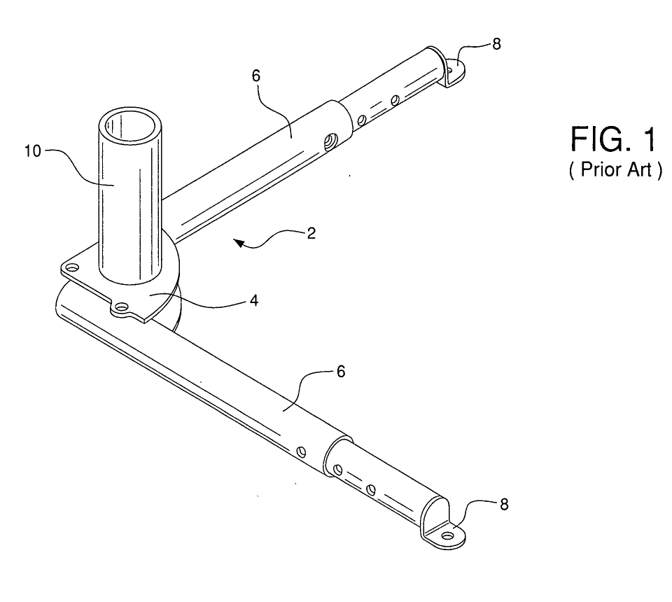

FIG. 2 is a perspective view of a lifting device of the present invention as mounted on the tailgate of an automobile.

FIG. 3 is a perspective view of the lifting device embodiment of FIG. 2.

FIG. 4 is a close-up side elevational view of the attachment of the lifting device of the type illustrated in FIGS. 2-3 to the structures of the automobile.

FIG. 5 is a top isometric view of a further embodiment of a lifting device base portion incorporating the features of the present invention.

FIG. 6 show various forms of automobile structures that may be used to secure the present invention to the frame of the automobile.

### DETAILED DESCRIPTION OF THE DRAWINGS

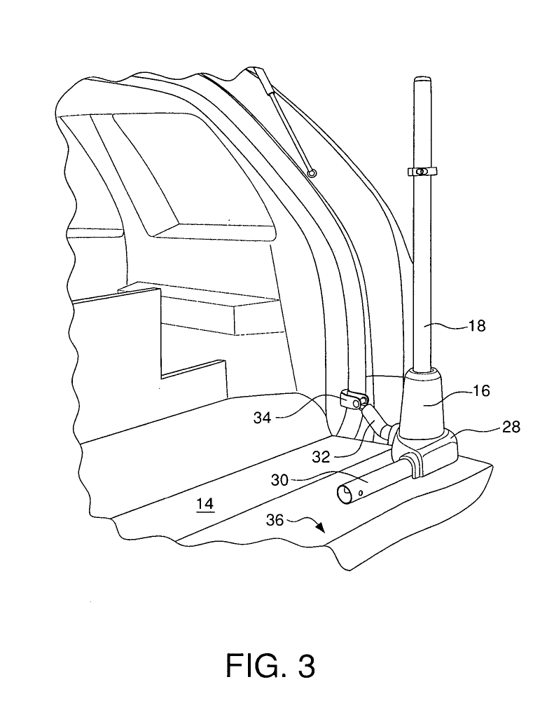

In the various figures there is shown various embodiments of a lifting device of the type contemplated by the present invention. In FIGS. 3-6, the lifting device is generally identified by the numeral 12 and is positioned within an automobile 14. It should be recognized that the general form of the lifting device, including its base portion 16, vertical shaft 18, boom arm 20, motor drive 22, cable 24, and hook (not shown) may vary as desired. As used herein, the term cable includes ropes, straps, tapes, chains, and the like. The motor drive 22 is electrically connected to the automobile power source and, as illustrated, is operated by a controller 26.

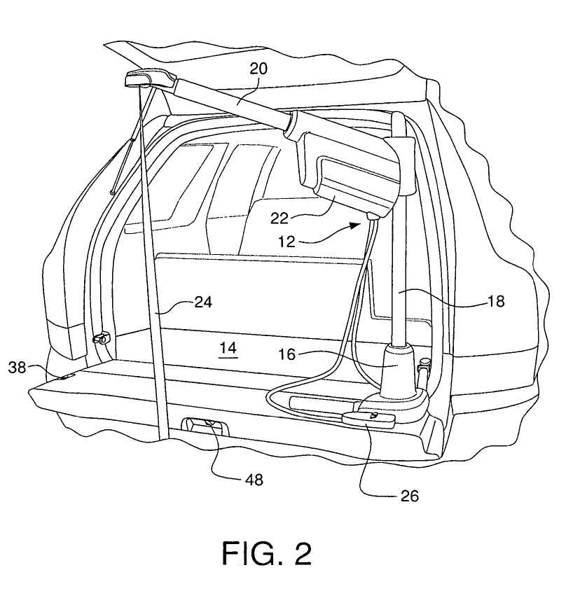

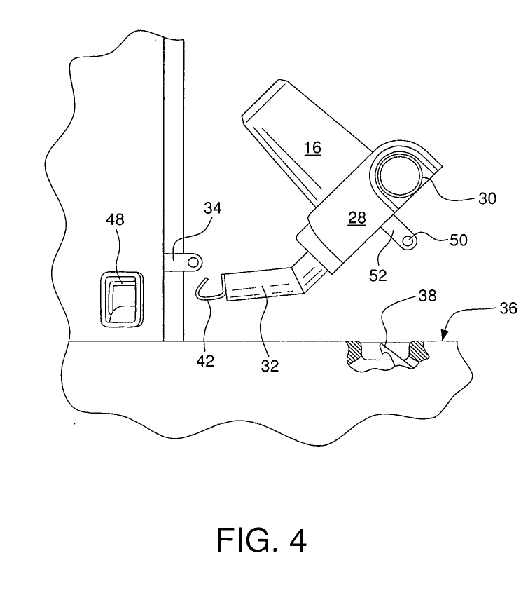

As more particularly illustrated in FIGS. 2 and 3, the base 16 of the lift 12 includes a base plate 28 having a first support arm 30 projecting there from and a second support arm 32 projecting toward the automobile 14 body and connected thereto at bracket 34, which is part of the automobile 14. The automobile 14 as illustrated in FIGS. 2-4 includes a rear hatch opening and a tailgate 36. The tailgate includes a latch mechanism 38 (viewed partially in FIG. 4) which engages bracket 34 mounted on the rear frame of the vehicle. A similar latch mechanism 38 is located on the opposite side of the tailgate 36 and is identified in FIG. 2. The latch mechanism 38 is controlled by a central handle 40. The latch mechanism 38 of the automobile 14 includes an engagement hook that wraps around a bar formed within the bracket 34. In FIG. 3, the second support arm 32 includes an angled extension having a securement hook 42 positioned at the projected end. The securement hook 42 engages the bar of the bracket 34 to secure the base 16 of the lift 12 on the tailgate 36. The base plate 28 and the first support arm 30 further stabilize the lift 12 on the tailgate 36. Thus, the lift 12 is secured to the automobile 14 by means of the existing structures formed on the vehicle, without the need to modify the vehicle.

The lift 12 may be stored within the vehicle until needed to lift a smaller vehicle into the transporting vehicle. The tailgate 36 is opened, and the hook 42 is secured around the bracket 34. The base 16 is placed on the tailgate 36, with the support arms 30, 32 resting on the tailgate to provide further support for the lift 12. The hook at the end of the cable 24 is connected to a smaller vehicle, for example, a personal mobility vehicle. The lift 12 is then used to move the smaller vehicle into or out of the transporting vehicle in a manner well known to those skilled in the art of lifts. Once the smaller vehicle has been moved to the desired location, the user may lift the base 16 from the tailgate 36, unhook the hook 42 from the bracket 34, and place the lift 12 in storage within the transporting vehicle until the next lifting operation.

In FIG. 4 there is illustrated an alternate version of a base plate 28 for the base portion 16 of the lift 12. The base plate 28′ includes a projection 44 extending downwardly from its lower surface. The projection 44 is positioned to engage the latch mechanism 38 of the type illustrated in FIGS. 2-3. The projection 44 has a generally U-shaped profile, including a central bar 50 extending between two legs 52 (only one of which appears in FIG. 4). The projection 44 is formed similarly to bracket 34 attached to the rear frame portions of the automobile. The projection 44 is engaged within the latch mechanism 38 to provide a further point of attachment for the lift structure 12 on the automobile 14. Again, the projection 44 attaches to the existing automobile structure and does not require separate mounting means, such as by drilling holes and inserting bolts to secure the base plate 28′ or support arms on the tailgate 36. As illustrated in FIG. 4, there are two points of attachment for the lift structure 12 on the automobile.

Although the projection 44 is illustrated as depending downward from the base 16, a projection 44 may also depend downward from the support arm 30, in addition to or as an alternative to a projection 44 mounted on the base 16. A projection 44 may be provided anywhere on the base 16 and/or support arms 30, 32, as long as the locations of the projections 44 correspond to the locations of the latches 38 provided within the tailgate or vehicle bed with which the lift 12 will be used.

As before, the lift 12 may be stored within the transporting vehicle until needed. The tailgate 36 is opened, and the hook 42 is secured around the bracket 34. The projection 44 is inserted into the latch mechanism 38, so that the latch mechanism 38 engages the projection 44 in the same manner as the latch mechanism would engage the bracket 34 if the tailgate were closed. The hook at the end of the cable 24 is connected to a smaller vehicle, for example, a personal mobility vehicle. The lift 12 is then used to move the smaller vehicle into or out of the transporting vehicle in a manner well known to those skilled in the art of lifts. Once the smaller vehicle has been moved to the desired location, the user may actuate the handle 40 to release the projection 44 from the latch mechanism 38. The user may then may lift the base 16 from the tailgate 36, unhook the hook 42 from the bracket 34, and place the lift 12 in storage within the transporting vehicle until the next lifting operation.

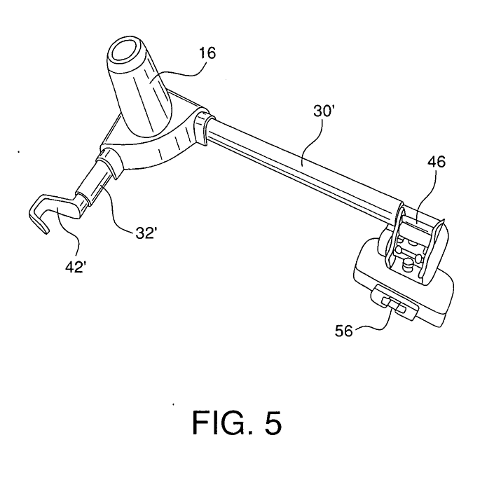

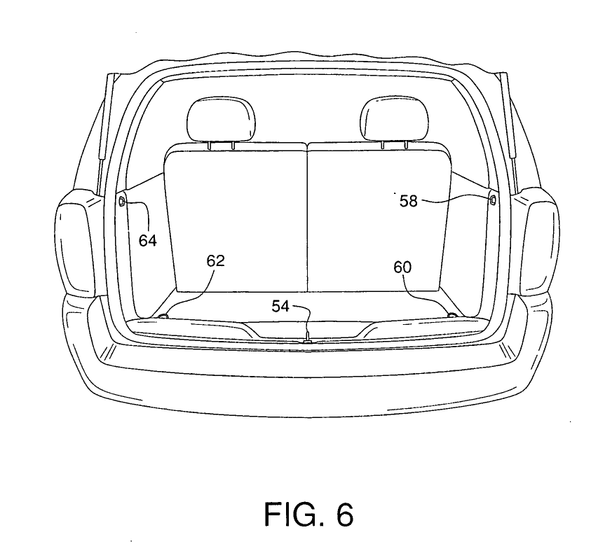

In FIG. 5 there is illustrated a further embodiment of the lift support base, incorporating two forms of attachment to a vehicle. The base 16 includes a first support arm 30′ having an attachment structure 46 at its projected end. The second support arm 32′ includes an alternate form of the attachment hook 42′ at its projected end. The engagement hook 42′ on the end of second support arm 32′ differs from the one illustrated in FIGS. 2-4 in that the hook structure will engage the bracket from the top, as compared to the hook 42 which engages from the bottom (see FIG. 6). A spring-biased keeper may also be provided on the hook 42′ to retain the hook in engagement with the bracket (34).

As shown in FIG. 5, the second form of attachment is mounting bracket 46 on the end of first support arm 30′. This mounting bracket 30′ is structured for use within a hatchback type vehicle (such as that shown in FIG. 6), wherein a single rear door or hatch lifts open, without a tailgate. A bar 54 (FIG. 6) extends across a receiving bracket at the base of the tailgate. In the embodiment shown in FIG. 8, the mounting bracket 46 includes a latch mechanism 56 similar to that formed in the hatch. This latch mechanism 56 engages the bar 54 to fixably secure the end of the first support arm 30′ to the automobile frame. In this manner, two attachment points are provided at opposite ends of base. A third attachment, such as projection 44 illustrated in FIG. 4, may also be incorporated.

The lift 12 may be stored within the transporting vehicle until needed. The hatch is opened, and the hook 42′ is secured around the bracket 34. The latching mechanism 46 is secured to the bar 54 in the same manner that the latching mechanism of the rear hatch would engage this bar 54. At this point, the base 16 is resting on the cargo bed of the transporting vehicle. The hook at the end of the cable 24 is connected to a smaller vehicle, for example, a personal mobility vehicle. The lift 12 is then used to move the smaller vehicle into or out of the transporting vehicle in a manner well known to those skilled in the art of lifts. Once the smaller vehicle has been moved to the desired location, the user may actuate the latching mechanism 46 to release the latching mechanism 46 from the bar 54. The user may then may lift the base 16 from the vehicle bed, unhook the hook 42′ from the bracket 34, and place the lift 12 in storage within the transporting vehicle until the next lifting operation.

In prior designs, there is a requirement that holes be drilled in the vehicle in order to secure the base of the lifting structure. In the present invention, a universal structure is provided to fix the lifting structure to the automobile. The bracket 34 illustrated in FIGS. 2-5 is but one form of the type of structure that may form a part of the automobile. Guide points, tie down loops such as loop 48 in FIG. 4, bars, guide bolts and the like may be provided, for example, attachment points 58, 60, 62, 64 (FIG. 6),. Thus, variation on the form of the attachment structure is contemplated. In addition, multiple attachments are possible, including but not limited to any combination of attachment mechanisms included in any of the above-described embodiments. Any securement point may be utilized. In addition, loops or hooks may be added to the automobile structure. Thus, the added attachment mechanisms are contemplated to become a permanent part of the vehicle, while the lift may be releasably secured to the vehicle.

There is no critical size for the lift structures, including the boom, base, or support arms. Each is dependent on the position of the latching structure on the automobile. The position of the attachments will vary depending upon the model, make and year of the automobile. A kit may be provided with multiple attachment structures to fit a variety of automobiles.

The present invention may be embodied in other specific forms without departing from the spirit or central attributes thereof. Accordingly, reference should be made to the appended claims, rather than the above description as indicative of the scope of the invention.

We claim:

1. A lifting device for lifting objects into and out of a transporting vehicle, said lifting device comprising:
a base,
an extending shaft attached to the base,
a boom fixably secured to the extending shaft,
a motor drive,
a cable extending along the boom, the cable attached at one end to the motor drive and at the other end projecting from the boom, and
the base including one or more support structures having attachment means thereon, at least one of the attachment means including an attachment element that engages a structural element of the transporting vehicle to secure and stabilize the lifting device on the transporting vehicle.

2. A lifting device as claimed in claim 1, wherein an attachment means is provided at multiple positions on the base to secure the lifting device to multiple structure elements of the transporting vehicle.

3. The lifting device according to claim 1, wherein:
the base includes a pair of support arms; and
one of the support arms includes a hook that is structured to engage a bracket within the transporting vehicle.

4. The lifting device according to claim 3, wherein the base includes a projection that is structured to engage a latching mechanism within a tailgate or within a bed of a vehicle.

5. The lifting mechanism according to claim 4, wherein the projection is generally U-shaped.

6. The lifting device according to claim 3, wherein the other of the support arms includes a latch mechanism that is structured to releasably secure a tailgate-securing bracket therein.

7. A lifting device for lifting objects into and out of a transporting vehicle, the lifting device comprising:
a base;
a shaft attached to the base;
a boom fixably secured to the shaft;
a motor drive;
a cable extending along the boom, the cable attached at one end to the motor drive and at the other end projecting from the boom; and
the base including at least one attachment element that is structured to releasably secure the base to a transporting vehicle.

8. The lifting device according to claim 7, wherein:
the base includes a pair of support arms; and
one of the support arms includes a hook that is structured to engage a bracket within the transporting vehicle.

9. The lifting device according to claim 8, wherein the base includes a projection that is structured to engage a latching mechanism within a tailgate or within a bed of a vehicle.

10. The lifting mechanism according to claim 9, wherein the projection is generally U-shaped.

11. The lifting device according to claim 8, wherein the other of the support arms includes a latch mechanism that is structured to releasably secure a bracket therein.

12. A method of lifting an object into a transporting vehicle, the method comprising:
providing a lift, the lift comprising:
a base;
a shaft attached to the base;
a boom fixably secured to the shaft;
a motor drive;
a cable extending along the boom, the cable attached at one end to the motor drive and at the other end projecting from the boom;
releasably securing the base to the transporting vehicle;
lifting the object into the transporting vehicle using the lift; and
releasing the lift from the transporting vehicle.

13. The method according to claim 12, wherein:
the base includes a pair of support arms, one of the support arms having a hook disposed at an end of the support arm; and
releasably securing the base to the transporting vehicle is accomplished by securing the hook to a bracket that is provided on the transporting vehicle.

14. The method according to claim 13, wherein releasably securing the base to the transporting vehicle includes releasably securing a projection disposed on the base within a latching mechanism provided on a tailgate or bed of the transporting vehicle.
